(19) United States
(12) Patent Application Publication
(10) Pub. No.: US 2005/0011587 A1
(43) Pub. Date: Jan. 20, 2005

(54) Log charger and charging system and method of transporting a preoriented log

(76) Inventors: Mike Warren, Lebanon, OR (US); Robert Presley, Albany, OR (US)

Correspondence Address: DELLETT AND WALTERS, P. O. BOX 2786, PORTLAND, OR, 97208-2786, US

(21) Appl. No.: 10/838,997

(22) Filed: May 5, 2004

Related U.S. Application Data
(60) Provisional application No. 60/484,863, filed on Jul. 2, 2003.

(51) Int. Cl. B27C 1/12

(52) U.S. Cl. 144/242.1

(57) ABSTRACT

A log charger system employs scan data to precisely orient a log rotationally prior to presenting the log to a carriage for sawing operations or the like. Once the log is rotated to the desired orientation, a V-shaped member picks the log up from underneath and moves it to the carriage. The V-shaped member has a lower-able or minimize-able side profile to enable it to retract away from the log, leaving it clamped to the carriage for further operations.

### BACKGROUND OF THE INVENTION

This invention relates in general to log charging systems, and in particular to a log charger, and log charging system for loading pre-oriented log onto a carriage, or other feed system, wherein the charger has a lower-able forward edge in order that the charger may be retracted from between the log and a carriage, or other feed system, frame member.

In operation of a sawmill, a log to be cut is placed on a carriage, which holds and moves the log through the saw, so as to cut boards from the log. Positioning of the log for the initial cut is important, as once the first cut is made, the log is essentially committed as to the manner in which it will be cut. In current practice, a log is rolled onto the carriage and dogged to hold it in position. Prior to dogging, the mill operator has the ability to manually rotate or jog the log somewhat, based on the operator's opinion of what might be the best orientation for the log, but otherwise once dogged, the position of the log is set. After dogging, the log is scanned, e.g., by passing it through a light curtain scanner and analysis of the log is done to determine the manner in which to cut the log. The log can be skewed some to alter the cut, but the operator is limited in the amount that the log can be moved. Based on the data input from scanning, it might be preferred to have the log in a different rotational orientation to provide a more optimal cut configuration, but it is not possible to accomplish this in accordance with the prior art, and the position at which the log is dogged on the carriage is essentially decided by chance or by the operator's feel of what might be a best orientation, limiting the options for providing an optimal opening face cut after scan data is analyzed. This imprecise initial positioning reduces the likelihood that an optimal cut and minimal waste can be accomplished, leaving it to chance.

It is known to analyze the shape of the logs processed, by a number of known scanning techniques, to maximize the board-foot yield. It is also known to adjust cut strategies to yield finished lumber cross-sectional sizes according to current conditions in a volatile market to maximize profit. The technology for analyzing the shape of the logs and for determining how they should be cut has become quite sophisticated. The software and scanners available today are able to provide sawmills with highly optimized theoretical yields. However, the methods and equipment to transport logs from the scanning process step to the sawing process step are inadequate and have left a gap between the theoretical best cut logs and the actual cut logs.

One solution is disclosed by Mierau et al in U.S. Pat. No. 5,765,617 wherein the scanning and rotation operations are combined in one system and the logs are held in desired orientation by a sharp chain conveyor. However, implementation of the system described therein requires mill re-layout and great tooling expense.

As noted above, in some sawmills, the mill will scan the logs just prior to sawing after the log is dogged such as by using a light curtain. One such system is disclosed by Hughes et al in U.S. Pat. No. 6,219,585 wherein a log is placed on a common type carriage and scanned by projecting a line of lasers from the top and detecting the shape of said line from a longitudinal side of the log perpendicular to the laser direction. The log is adjusted horizontally on the carriage by a number of movable headblocks and adjusted vertically at a number of contact points. However, scanning and positioning the logs just prior to sawing has a number of disadvantages. First, once the log is on the carrier the amount of possible repositioning is limited, thereby limiting the level of optimization. Second in line scanning of the logs slows mill throughput verses off-line scanning which enables smoother more continuous flow. In addition, scanning and positioning on the carriages often requires manual intervention.

A great many mills are equipped with a common knee carriage type similar to the one disclosed in U.S. Pat. No. 6,219,585 discussed above. Other examples of common carriages are those produced by the McDonough company of Eau Claire Wisconsin which comprise a rectangular frame with wheels which ride on tracks arranged to convey a log longitudinally toward and through a saw. Mounted above the substantially horizontal frame are a number of (for example three) ways or bunks upon which the logs are dropped. The ways or bunks are oriented substantially perpendicular to the longitudinal axis of the log. Headblocks extend from the frame and often include tooth shaped dogs to hold a log in place. The ways can be horizontal, or angled to gravitationally bias the log toward the headblocks.

FIGS. 1a through 1f are side views which illustrate a conventional log loading system through various steps in a typical loading process. A log 10 is rolled from the left to right in the view of FIG. 1a, where it reaches stop and loader arm 12, which holds the log at a stop position while awaiting transfer to the carriage. The stop and loader arm pivots about an axis 14, and as it pivots, the right most end of the arm moves downwardly, as may be observed in the successive views of FIGS. 1b-1e. As the arm pivots, the shape and configuration of the leftmost end acts as a stop to prevent the next log 10′ being log 10 from continuing to roll toward the right. This enables a single log at a time to be transferred to the carriage. In the view of FIG. 1f, the arm 12 has moved to its lowermost position, and the log 10 has rolled onto the carriage 18. In the view of FIGS. 1a-1f, a scanner 16 is mounted above the carriage and is oriented to provide a view of the carriage with the log thereon.

It will be apparent that the rotational orientation of the log on the carriage is based on chance. The log may be roughly re-positioned before dogging by use of a log turner 20 once the log is placed onto the common type carriage 18 where it is manually rotated and dogged, then scanned to determine the best way to cut the log in that position. In FIG. 1a-1e, the log turner 20 is shown in its retracted position, while it is not in use. In FIG. 1f, the log turner is shown in several positions which it may take during operation. The log turner may be pivoted toward the left of the view of FIG. 1f to accommodate different size logs, as shown at 20′, and is extended upwardly as shown at 20″, to jog the log and cause rotation thereof in the direction of arrow 22. When the optimal cutting solution is obtained the log is positioned horizontally via the carriage knees to achieve the optimum opening face. Then the common type carriage 18 transports the log thru the sawing device. A common carriage as shown here includes a rigid frame with wheels attached to an underside thereof which ride upon tracks in order to move the log 10 to and through a saw blade (not shown). Attached to an upper side of the frame re ways or bunks which receive the logs 10 for sawing. A hold down dog comes down to hold the log 10 in place.

This rough positioning of the log has been tolerated in the industry and it is generally considered sufficient to get the log to within 15 to 20 degrees of optimal. However, as discussed, scanning and optimizing technology has advanced but optimal log positioning onto the carriage or other feed systems has not.

### SUMMARY OF THE INVENTION

In accordance with the invention, a system is provided where a log is rotated to a desired configuration prior to placement on a carriage, using scan data based on a scan of the log. The system rotates the log to the desired orientation for cutting, picks the log up and presents it to the carriage without any loss of theoretically obtained orientation. The carriage then can clamp the log in place and begin sawing operations.

Accordingly, it is an object of the present invention to provide an improved system for orienting a log and presenting it to a carriage.

It is an object of the invention to eliminate or otherwise minimize the dropping, or otherwise imprecise loading of logs onto a carrier or other type of feed system.

It is an aspect of the invention to be usable with other feed systems wherein theoretical optimal positioning is not lost upon moving the logs from scanning to sawing.

It is another aspect of the invention that the charger can be made to fit between existing openings in existing analyzing and turning equipment, and made to fit between existing openings in existing carriers or feed systems thereby being easily retrofitted into existing sawmills at minimal expense.

It is another aspect of the invention that logs processed by a mill are more rigidly and reliably oriented to the carriage or feed system throughout the sawmill process steps from having been optimally scanned, thereby enabling automated carrier operation and a higher level of sawmill automation.

It is a further-object of the present invention to provide an improved system to retrofit an existing log carriage to provide high precision orientation.

It is yet another object of the present invention to provide an improved log carriage system employing scan data to precisely orient a log to a carriage.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements.

### BRIEF DESCRIPTION OF THE DRAWINGS

FIGS. 1a through 1f are side views which illustrate a conventional log loading system;

FIGS. 2a through 2f are sectional side views, taken along the line 2-2 on FIG. 3, of a system according to the invention showing the steps maintain proper orientation of an optimally positions log;

FIG. 3 is an elevation view taken orthogonal to the views shown in FIGS. 2a-2F;

FIGS. 4a and 4b are side views of an alternate log carrying V-channel;

FIGS. 5a and 5b are side views of another alternate log carrying V-channel; and

FIG. 6 is a flow chart of operational steps employed in accordance with the invention.

### DETAILED DESCRIPTION

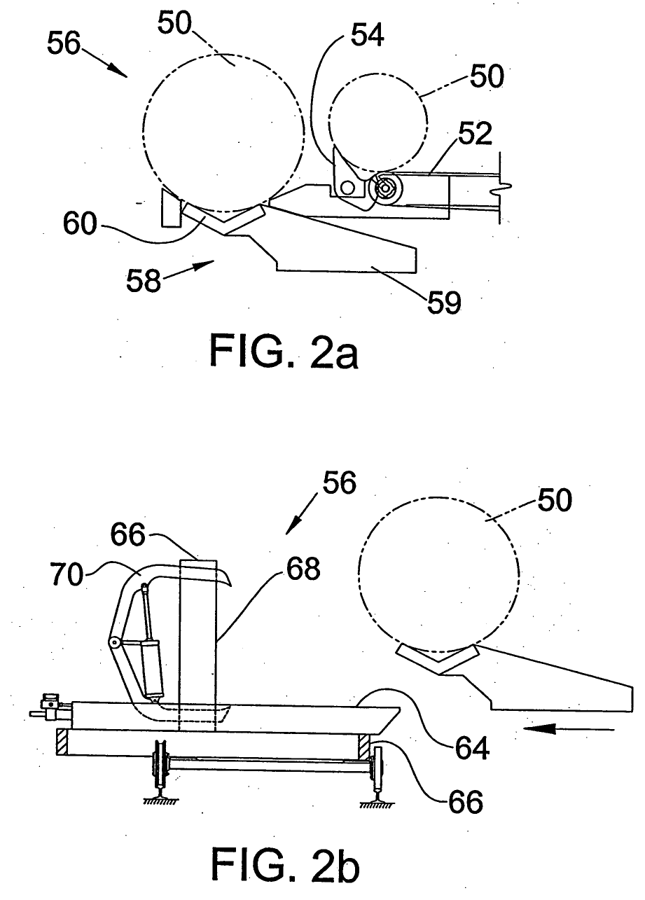

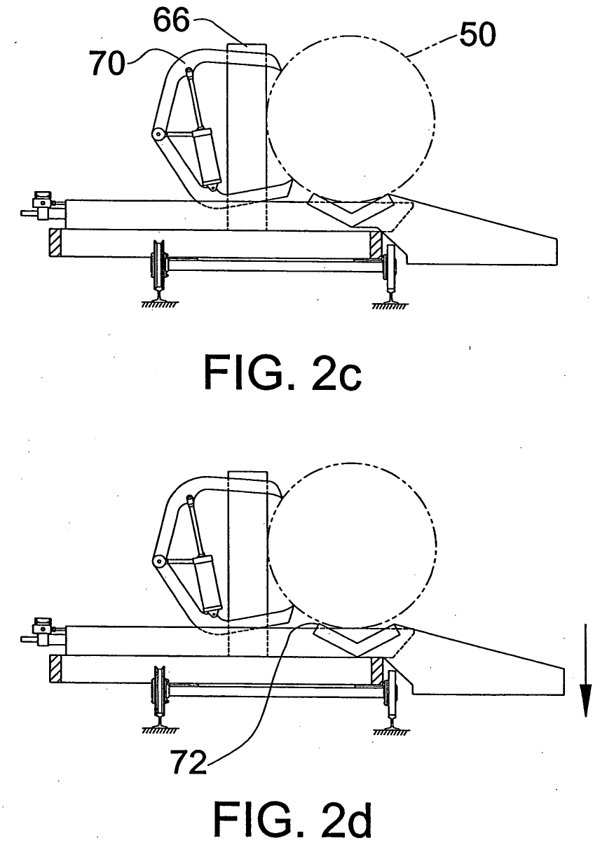

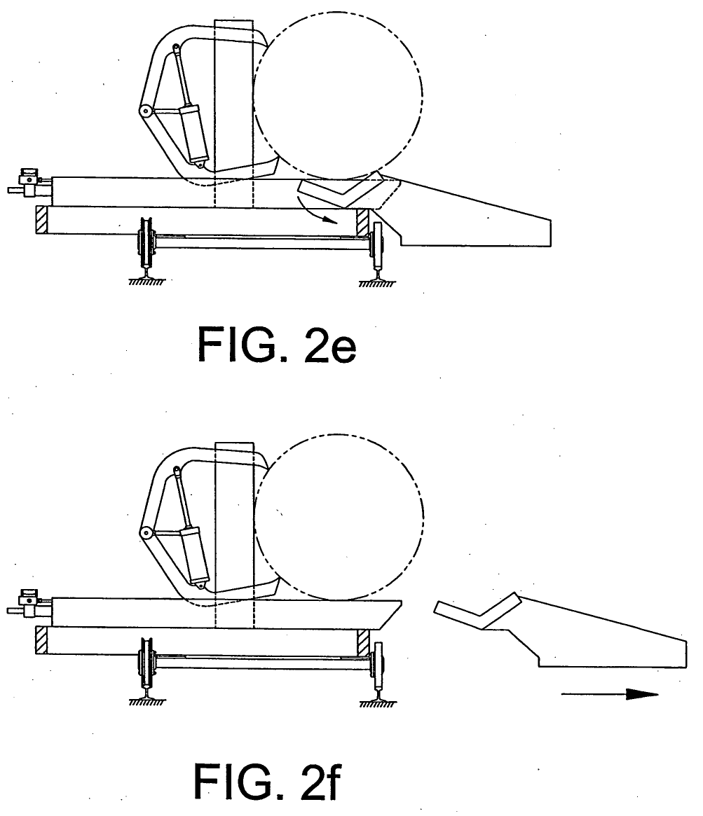

FIGS. 2a-2f are sectional side views which show the system according to a preferred embodiment of the present invention and comprises a system to orient and precisely place a log on a carriage in a way to maintain the precise orientation.

In accordance with the present invention FIG. 2a shows logs 50 being presented by a conveyor 52 one at a time in a controlled fashion via stop and loader arm 54 to a log presentation station 56 wherein each log 50 is rotated in a precision manner by log turners, which suitably comprise chain turners (not shown) which move upwardly and engage, for example, the underside of the log. The chain turners rotate, whereby the log is caused to rotate so that the log is rotationally oriented to a desired degree so that the desired cutting configuration is produced. The position to which the log is rotated is suitably determined based on scan data from an earlier scan of the log, and this data is used to determine an optimal rotational orientation of the log to provide a desired position for a best opening cut. What is considered “best” may depend on many factors and may change from moment to moment, depending on whether logs are to be cut for maximum yield of particular dimensions of wood, maximum profit, or any other decision base.

The invention provides the device which rotates the log, using the prior scan data of the log, to the determined log orientation to then provide the desired rotational orientation of the log. The system thus rotates the log so that it is in the desired orientation. Then, a pair of chargers each having a set of extendible arms 59 which include overhung V-shaped channels 60 into which the log is carried, move up into spaces between the individual rotation devices, whereby the log is lifted while maintaining its rotational orientation. A holding arm (not shown in this embodiment) can be advantageously employed. The extendible arms 59 pick the log up by bringing the V-shaped channels 60 up to take the log off the rotation device. FIG. 2b shows the log 50 being carried forward by the extendible arms 59 and being placed onto the carriage 62 in FIG. 2c maintaining a particular position and a particular rotational orientation of the log 50. In this way, the log is now presented to the carriage in an orientation that is much more precise than in accordance with the prior art, where the initial orientation was based on chance as the log rolled onto the carriage, and the ability to rotate the log was very limited and imprecise.

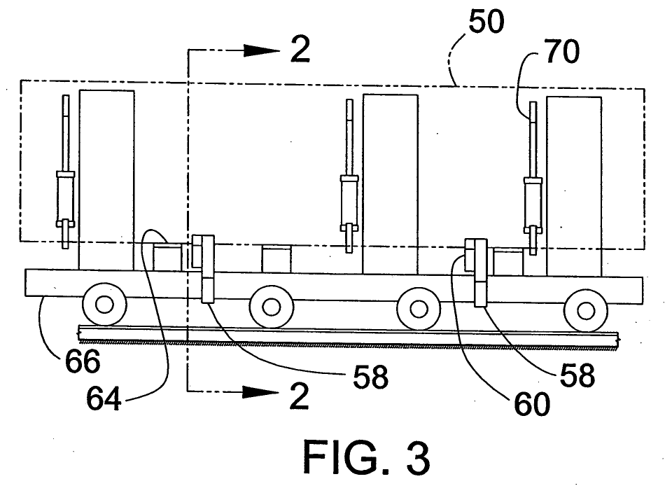

The carriage 62 has a number of spaced apart ways or bunks 64 (as also shown in elevation FIG. 3) which are arranged above a frame 66. The log 50 contacts the carriage via the ways 64 on the bottom of the log and contacts horizontally adjustable headblocks 66 via knees 68. The overhung V-shaped channels 60 of the extensible arms 59 reach over the frame 66 and enable the log 50 to make contact with the ways 64 while the log 50 is still precisely oriented in the charger.

The carriage is then directed to clamp the log into place thereon, by use of tong dogs 70, whereupon the forward edge of the V-channel moves downward enabling the extensible arms to retract away, as discussed below, leaving the log mounted on the carriage in a precision rotational orientation, ready for sawing.

After the log 50 is secured onto the carriage 62 in the precise orientation as determined by the log scan analysis the extensible arms 59 of the charger 58 are able to free themselves from being pinned between the log 50 and the frame 66 by the following: The extensible arms move downwardly as shown in FIG. 2D transferring the weight of the log 50 to the ways 64. Then the V-shaped channels 60 are made to pivot (FIG. 2e) thereby lowering or minimizing the forward edge 72 of the charger 58 below the bottom surface of the log 50. Then the extensible arms 59 are free to be extracted from the carriage 62 (FIG. 2f). The V-channels are repositioned to pick up the next log as the charger 58 moves back to the log presentation station 56.

The system controls the operation of the carriage also, whereby it can cooperatively interact with the carriage.

Elements of the system include:

In order to precisely position the log, rotational scan information from a previously completed scan of the log is employed (done to determine the size and shape and optimal cutting of the log).

Presenting the log to the carriage by the system, in a precise orientation and location on the carriage.

Controlling the overall operation of the carriage in conjunction with operation of the log scanning and orienting system.

The system provides an improvement in that the log is presented to a standard style head rig and carriage by use of the V-shaped arms, which pick the log and move it onto the carriage while maintaining the precise log orientation, and then move down and away from the log to release it.

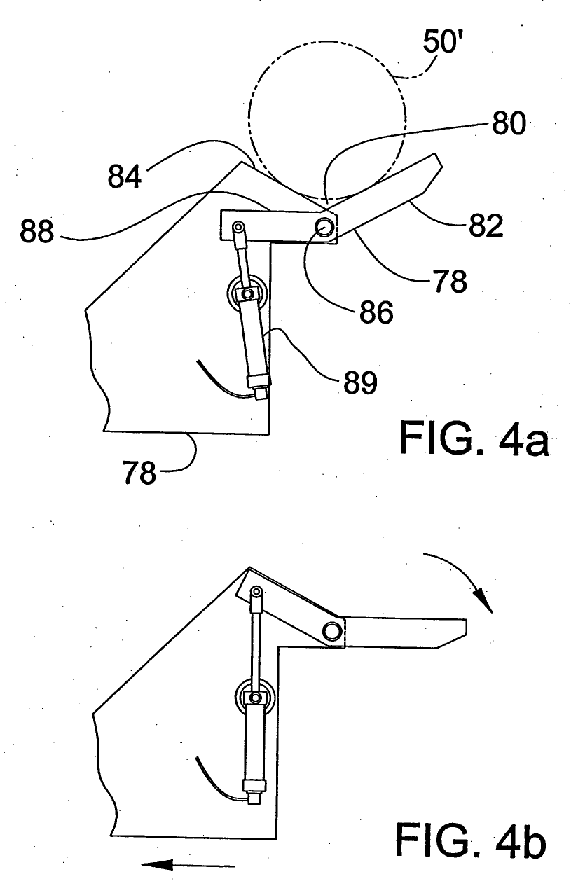

An alternative log carrying V-channel is shown in FIGS. 4a and 4b. Extensible arms 78 include V-shaped channels 80 created by a distal movable arm 82 and a near fixed sloping surface 84. The movable arm 82 pivotally connected at a fulcrum point 86 to each extensible arm 78. The movable arm 82 includes a log holding side 86 and a lever arm side 88, which form an angle with each other, with a fulcrum point 86 in the middle thereof. Once the log 50′ is placed on a carriage (not shown) the lever arms 86 are raised by actuation means 89 thereby lowering the movable arm 82 enabling the extensible arms 78 to extract themselves from under the log 50′ in a fashion similar to that discussed and shown in FIGS. 2d-2f. It should be understood the angle formed between, and the relative lengths of, the log holding side and the lever arm side can be any angle without departing from the invention.

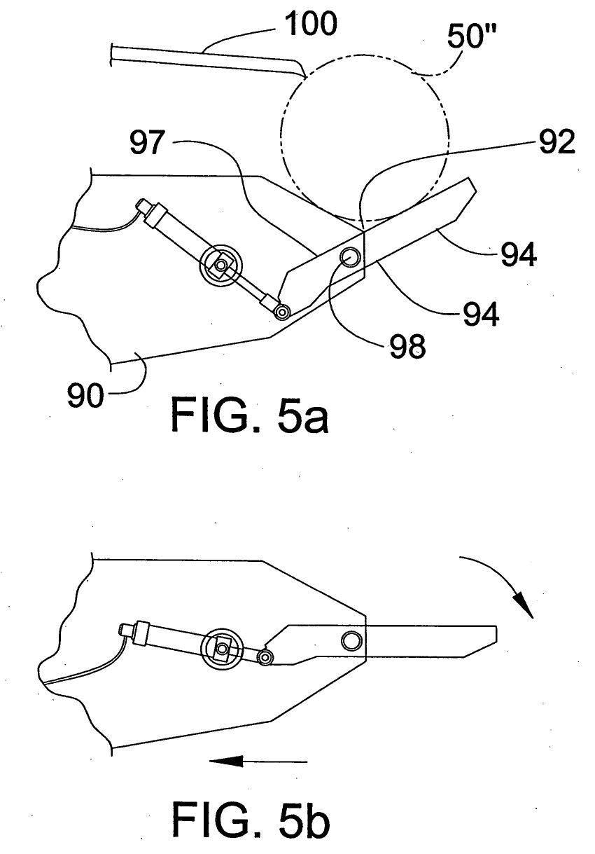

Another embodiment of the invention shown in FIGS. 5a and 5b illustrates using a straight movable distal arm. In this version each extensible arm 90 has a V-channel 92 which includes a movable front or distal leg 94 having a log holding side 96 and a lever arm side 97 connected at a fulcrum point 98 to the extensible arms 90. A hold down dog 100, connected to at least one extensible arm by a suitable means, comes down on a top surface of the log to ensure the log 50″ stays in place. The distal arm 92 can be moved down, e.g. to a flat horizontal configuration, to “get out of the way” of the log when retracting away from the log after the log has been placed on the carriage.

In any event, once the log is presented to the carriage, the carriage is directed to clamp the log, and then the V arms may be retracted.

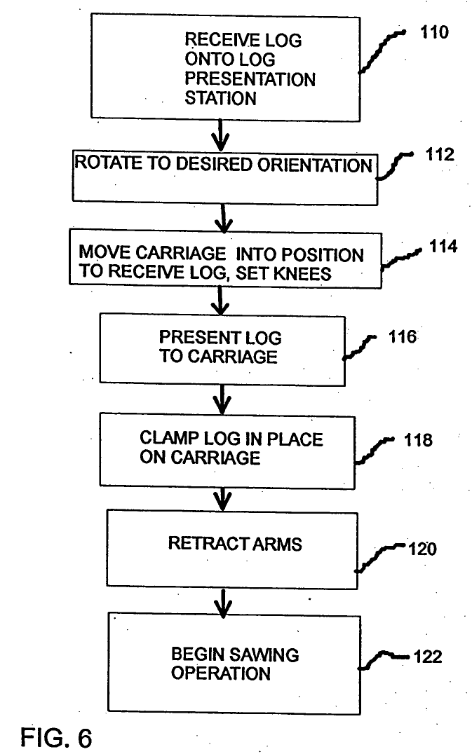

A flow chart of control steps is shown in FIG. 6. The system according to the invention suitable will control operation of the carriage and sawing. First, the log is received onto the presentation station 56 (block 110), and using the data from a previously completed scan, the log is rotated to a specific orientation so that the log can be presented to the carriage in an optimal position (step 112). Next the system will direct the carriage to move to a position so as to be ready to receive the log thereon (block 114), which may include setting the knees on the carriage so as to also configure the skew of the log when it is mounted on the carriage, whereupon the log is presented to the carriage (step 116) in its optimal rotational position, in the manner discussed hereinabove. In block 118, the system now directs the clamping system of the carriage to activate so as to secure the log in the proper position on the carriage. In block 120, the arms are now retracted away from the carriage, and the sawing operation can now begin (block 122). The advantage provided is that the log has been set and clamped to the carriage in a precise rotational orientation, so as to provide maximum control of the operation.

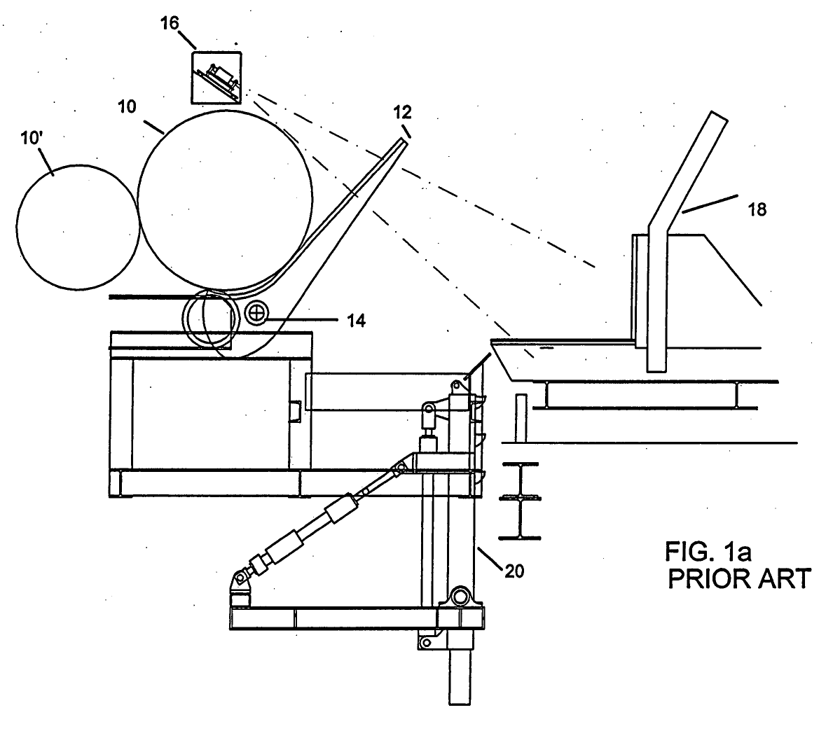

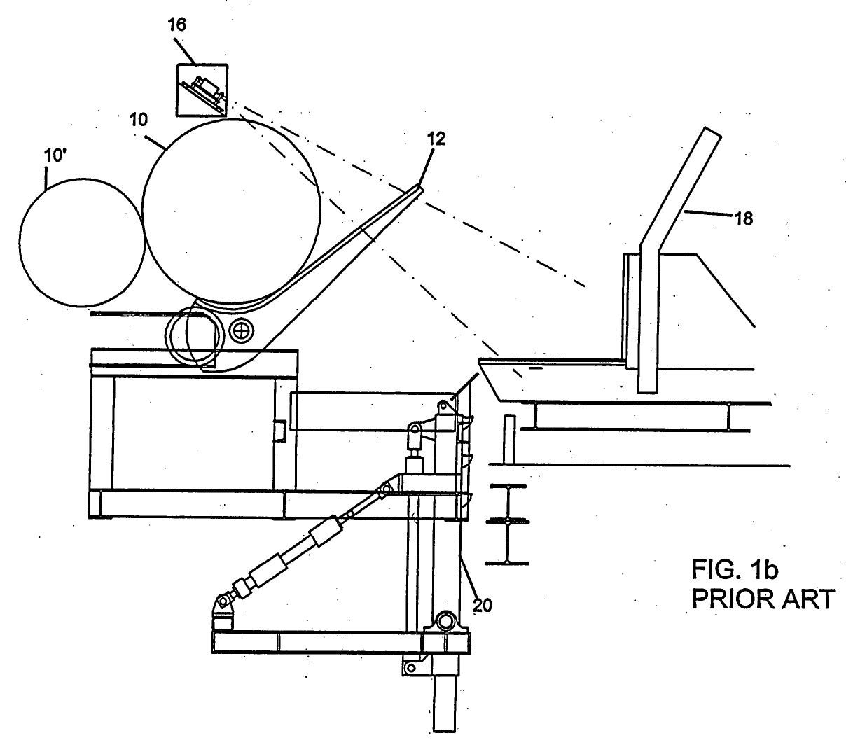

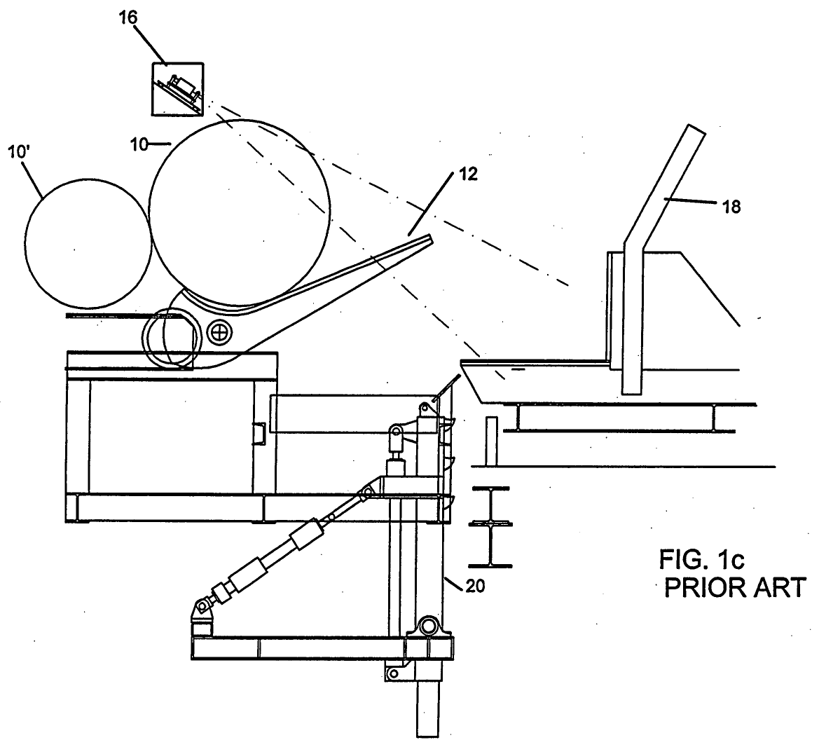

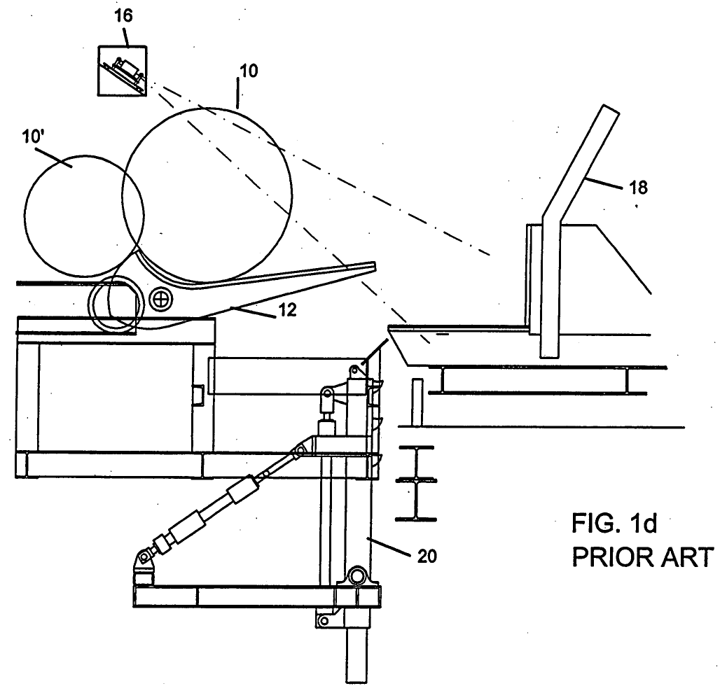

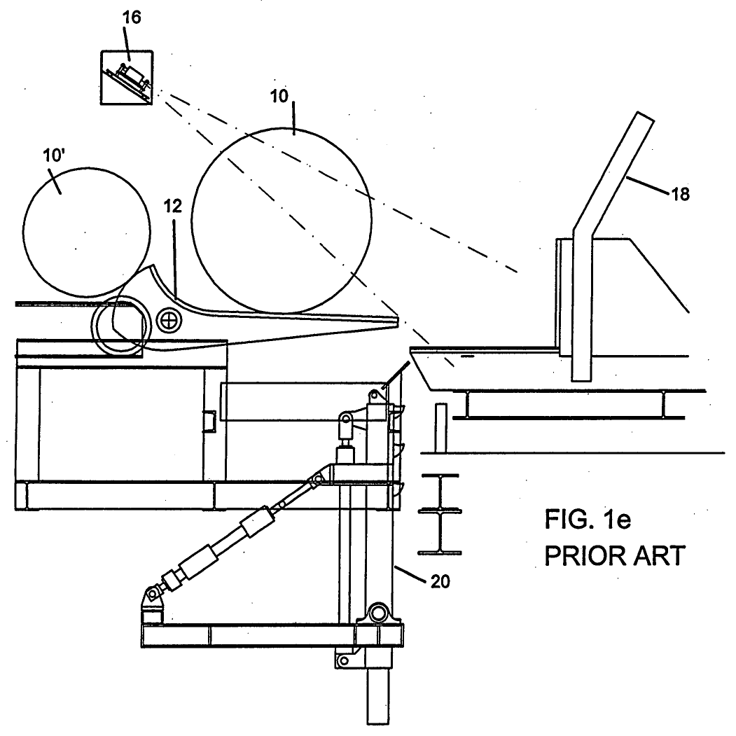

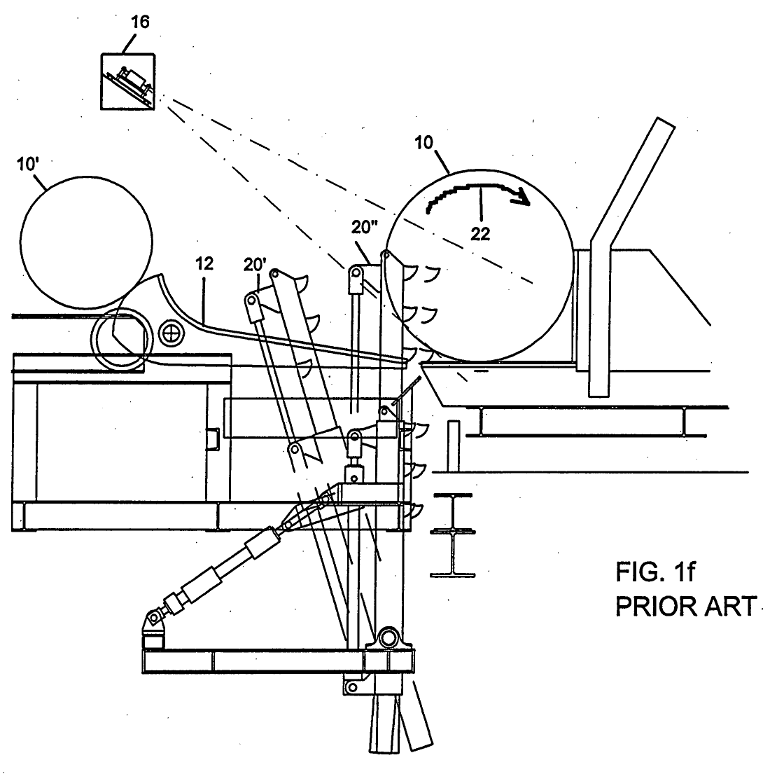

Thus, in accordance with the invention, a system of presenting a log in a precise orientation to a carriage is provided. The system enables use with a standard type carriage, such as the side loading type carriage of FIG. 1, enabling a precision log orientation to be provided with a standard carriage.

The system can be advantageously employed with an existing log carriage of the side loading type, for example, enabling a retrofit operation to upgrade the capability and accuracy of an existing sawing operation. The system presents the log to the carriage in an accurate, precisely positioned orientation. Scan information from a log scanning system is employed in the rotational determination, and the operation of the carriage (for receiving, clamping, sawing the log) is controllable by the system.

While plural embodiments of the present invention have been shown and described, it will be apparent to those skilled in the art that many changes and modifications may be made without departing from the invention in its broader aspects. The appended claims are therefore intended to cover all such changes and modifications as fall within the true spirit and scope of the invention.

1. A log charger system for presenting a log to a carriage in a precise orientation, comprising:
log rotating mechanism for rotating the log to a desired orientation; and
log presenting device for presenting the oriented log to a carriage.

2. The log charger system according to claim 2, wherein said log presenting device comprises a translatable V arm for moving the log onto the carriage and then retracting away.

3. The log charger system according to claim 3, wherein said translatable V arm comprises a movable arm portion adapted to move between a log holding position and log releasing position.

4. The log charger system according to claim 2, wherein the translatable V arm is lowerable below the surface of the log enabling the presenting device to retract away with minimal vertical movement.

5. A device for cradling moving and placing a log down on a carriage surface comprising at least one side of the device which forms a cradle being movable so the device can be removed from the log by a substantially horizontal movement.

6. A device for cradling moving and placing a log down on a carriage surface according to claim 5 further comprising a first stationary angled surface and a second pivotal surface having a pickup position and a retreat position.

7. A method of transporting a pre-oriented log comprising the steps of:
lifting a log with a charger from a first location wherein the log has been rotated to an optimal yield orientation, the charger having a first angled surface and pivotal second surface having an angled orientation forming a cradling-V to cradle the log;
translating the log with the charger to a feed system, the feed system having surfaces upon which to place the log, the receiving surfaces having spaces therebetween, the charger fitting between the spaces, and placing the log onto the receiving surfaces;
pivoting the pivotal surface of the charger downward below the log freeing the charger to move away from the feed system.

8. The method according to claim 7 wherein the first and second surfaces are rigidly connected and pivot together.

9. The method according to claim 7 further comprising the step of placing a hold down dog onto the top of the log prior to said lifting step.

10. A log charger comprising a pivotal V-shaped channel connected to the charger being positionable under a pre-positioned log enabling the charger to pick up the pre-positioned log and to pickup and transport the log onto a carrier, said charger being positionable between spaced apart carrier surfaces, said V-shaped channel pivoting downwardly so that said transport arm can be moved horizontally away from the log.
